(19) United States
(12) Patent Application Publication
(10) Pub. No.: US 2008/0265074 A1
(43) Pub. Date: Oct. 30, 2008

(54) Mill Liner Assembly

(76) Inventors: Ricardo Abarca Melo, Santiago (CL); Ricardo Fernandez Daberti, Santiago (CL)

Correspondence Address: Julie K. Morriss;Morriss O'Bryant Compagni, 734 East 200 South, Salt Lake City, UT, 84102, US

(21) Appl. No.: 11/795,654

(22) PCT Filed: Jan. 16, 2006
(86) PCT No.: PCT/AU06/00049

§ 371 Date: Feb. 27, 2008

(30) Foreign Application Priority Data
Jan. 18, 2005 (CL) 0102-2005

(51) Int. Cl. B02C 1/10

(52) U.S. Cl. 241/299

(57) ABSTRACT

A liner assembly for use in a grinding mill, the liner assembly including a liner body including a mounting member, and an elastomeric cushioning member operatively connected to the mounting member. The cushioning member includes a plurality of support cavities therein, and a plurality of wear elements mounted within the support cavities.

The present invention relates generally to the crushing, grinding, comminuting or similarly processing materials such as mineral ores, rock and other materials, and more particularly to apparatus for use in such processing. In one example application sulphurated minerals are processed to produce particulated matter of a size between 100 and 20 microns.

Grinding mills are one form of apparatus used for processing materials as described above. Typical grinding mills generally comprises a drum shaped shell mounted for rotation about its central axis. The axis of the shell is generally horizontally disposed or slightly inclined towards one end. The interior of the shell forms a treatment chamber into which the material to be processed is fed. In one form of mill known as a SAG (semi autogenous grinder) a grinding medium such as balls or rods is fed to the treatment chamber with the material to be processed. During rotation of the shell the grinding medium acts on the material to cause the crushing or grinding action. In conventional mills and SAG mills the aspect ratio of the mill diameter to the mill length is ≦1 and >1 respectively. The grinding medium and material to be processed are carried up the side of the shell as a result of the centrifugal force created by rotation of the shell whereafter it falls towards the bottom of the shell under the influence of gravity. To assist in lifting the material up the side of the shell lifter bars are often provided which are secured to the interior surface of the shell. The lifter bars extend generally longitudinally of the shell and are circumferentially spaced apart around the inner surface. The higher the material travels up the shell the better the grinding of the material. Examples of such mils are described in Chilean Patents 39450 and 36411.

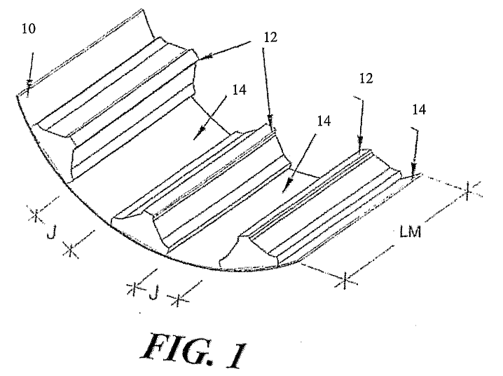

FIG. 1 is a partial schematic illustration of a typical grinding mill having a shell 10 with a plurality of lifter bars 12 mounted to the inner surface of the shell 10. The lifter bars 12 are circumferentially spaced apart around the inner surface of the shell 10 and extend in the direction of the axis of rotation of the shell. The spaces between adjacent lifter bars 12 form channels 14 of width J. The length of the bars 12 is shown as LM which is the inner length of the shell in the direction of rotation thereof. Preferably the number of channels 14 is the same as the number of lifter bars 12.

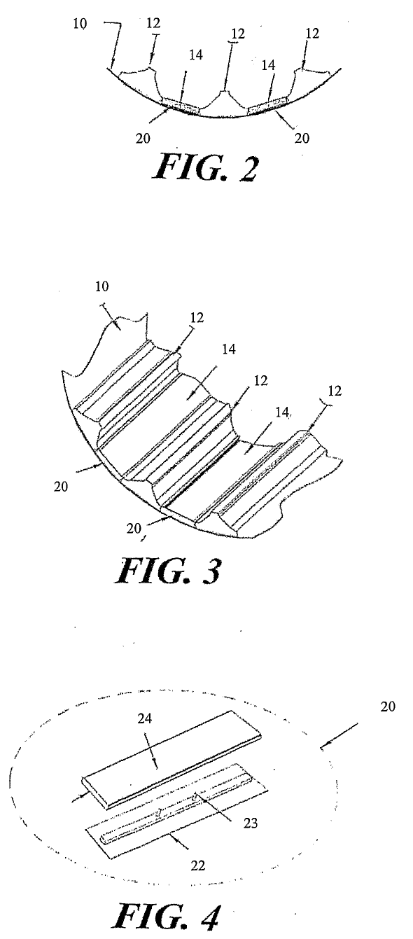

FIGS. 2 to 4 are various illustrations of conventional liner assemblies adapted to be installed in mill shown in FIG. 1.

As shown in FIG. 2, each channel 14 is adapted to have mounted therein a liner assembly 20. The conventional liner assembly 20 includes a metal base member 22 which is adapted to be mounted to the inner surface of the shell by suitable fastenings such as bolts (not shown). The base member 22 includes an elongated plate having mounting elements 23 thereon. The liner assembly further includes a generally flat wear element 24 which is mounted to the base member 22. The wear element 24 may be formed of an elastomeric material or metal for providing protection against abrasion and impact. Because of the constant impact forces applied to the wear elements when the mill is in operation they will tend to break after a period of time, when breakage occurs the mill needs to be stopped while they are replaced. This can be time consuming and reduce the overall productivity of the mill.

It is an object of the present invention to provide an improved mill liner assembly which alleviates the aforementioned problem.

According to one aspect of the present invention there is provided a liner assembly for use in a grinding mill, the liner assembly including a liner body including a mounting member, an elastomeric cushioning member operatively connected to the mounting member, said cushioning member including a plurality of support cavities therein, and a plurality of wear elements mounted within the support cavities.

The line assembly according to the present invention is suitable for use which includes a rotatable shell having a plurality of lifter bars on the inner surface thereof, the lifter bars extending generally in the same direction as the axis of rotation of the shell. The lifter bars are circumferentially spaced apart around the inner surface of the shell so as to form channels therebetween. Preferably the liner assemblies are disposed within the channels with the mounting members secured to the inner surface of the shell.

In one form the cushioning member may be an elongated body having the cavities arranged in a row extending in the longitudinal direction of the elongated body. Two or more rows of cavities may be arranged side by side. In one form the cavities in one row may be offset with respect to cavities in an adjacent row. The length of the cushioning member may be between 2 to 12 times the width of the member.

In one form the liner body may include a base wall, opposed side walls extending away from the base wall and terminating at an outer edge and an outer wall extending from the outer edge of the side walls. The distance K from the base wall to the outer edge of the side walls may be about the width of the lifting bar. The distance M from the outer edge of the side walls to an outermost region of the outer wall may be about 1 to 40 cm.

The cavities may include a lower wall and the distance S from the base wall of the liner body to the lower wall of the cavities may be from 0.1 K to 0.9 K where K is the distance from the base wall to the outer edge of the side walls of the liner body.

The elastomeric cushion may have a Shore hardness between 30 to 85 hardness Shore A.

Adjacent cavities in a row may be separated by a wall having a thickness from about 0.5 mm to 20 mm. The wear elements may be generally polyhedric in shape. The wear elements may have a Brinell hardness of between 350 to 800 BHN. Preferably the outer surface of the outer wall of the liner body is substantially defined by an outer surface of the wear elements.

The side walls of the body may be slightly inclined towards one another.

Preferred embodiments of the invention will hereinafter be described with reference to the accompanying drawings.

FIG. 1 is a partial cross-section of an axonometric view of a mill without protective liners;

FIG. 2 is a partial view of an elevated cross-section perpendicular to the axis of the mill with conventional protective liner assemblies;

FIG. 3 is a partial cross-section of an axonometric view of a mill with conventional protective liner assemblies;

FIG. 4 illustrates the features of a conventional protective liner assembly;

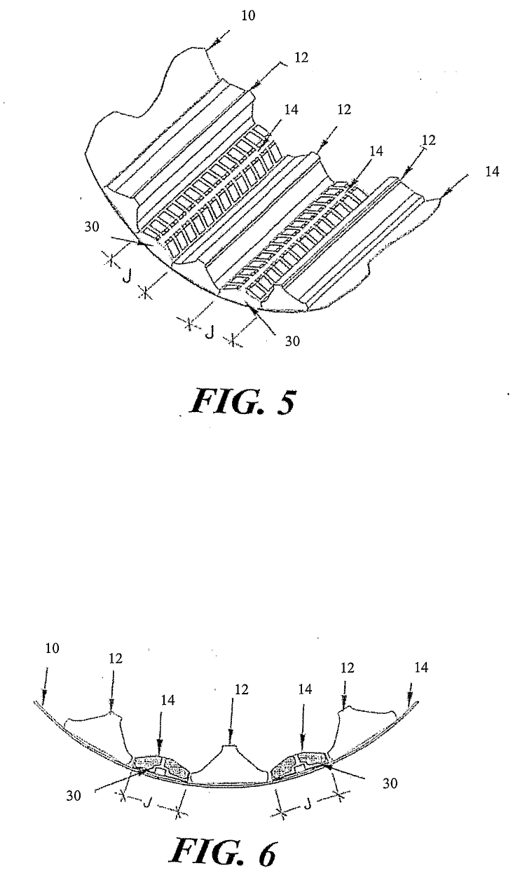

FIG. 5 is a partial cross-section of an axonometric view of a mill with protective liner assemblies according to the present invention;

FIG. 6 is a partial view of an elevated cross-section perpendicular to the axis of the mill with liner assemblies according to the present invention;

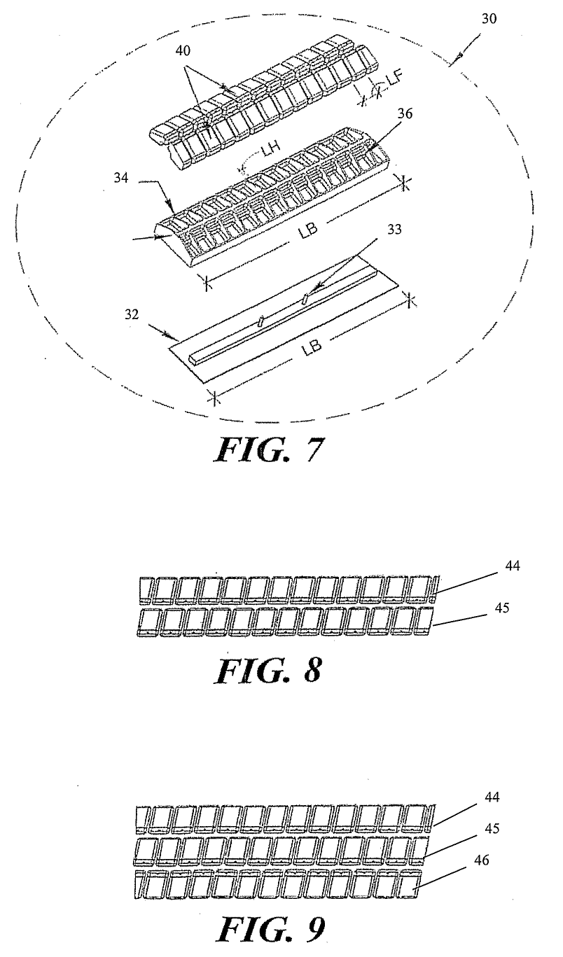

FIG. 7 is a view of the protective liner assembly according to the present invention;

FIG. 8 is a plan view of a preferred form of wear element of the liner assembly of the present invention;

FIG. 9 is a plan view of another preferred form of wear element of the liner assembly of the present invention; and

FIGS. 10, 11, 12, 13, 14, 15 and 16 are different configurations of the wear element and the surface exposed to the impact of the apparatus according to the present invention.

A partial view of a typical grinding mill is shown in FIG. 1 having conventional liner assemblies has been described earlier with reference to FIGS. 2 to 4.

FIG. 5 is a partial schematic illustration of a grinding mill with liner assemblies according to the present invention. The mill has a shell 10 with a plurality of lifter bars 12 mounted to the inner surface of the shell 10. The lifter bars 12 are circumferentially spaced apart around the inner surface of the shell 10 and extend in the direction of the axis of rotation of the shell. The spaces between adjacent lifter bars 12 form channels 14 of width J. The length of the bars 12 is shown as LM which is the inner length of the shell in the direction of rotation thereof. Preferably the number of channels 14 is the same as the number of lifter bars 12.

Each channel 14 is adapted to have mounted therein a liner assembly 30 in accordance with the present invention. The liner assembly 30 includes a base member 32 which is adapted to be mounted to the inner surface of the shell by suitable fastenings such as bolts (not shown). The base member 32 includes an elongated plate having mounting elements 33 thereon.

The liner assembly further includes an elastomeric cushioning member 34 which is secured to the base member 32. The cushioning member 34 has a plurality of cavities 36 therein for receiving wear elements 40. The width of the liner assembly is about the same as the width of the channels 14 between adjacent lifter bars 12 and the length of the liner assembly is between 2 and 12 times the width of the member.

The liner assembly has a base wall having an underside which substantially conforms to the curvature of the inner surface of the shell and side walls extending from the base wall and being of a height K which is approximately the same as the height of the side walls of the lifter bars 14.

As shown in FIG. 8, the wear elements are arranged in two rows 44 and 45 in which the elements are offset from one another. In FIG. 9 three rows 44, 45 and 46 are shown with the elements in adjacent rows being offset from one another.

The wear elements may be formed from metal, a metal alloy, ceramic or any other suitable material. The wear elements preferably have a Brinell hardness between 350 and 800 BHN. The cushioning member may be a natural or synthetic material or a combination of both with a Shore hardness between 30 to 85 hardness Shore A.

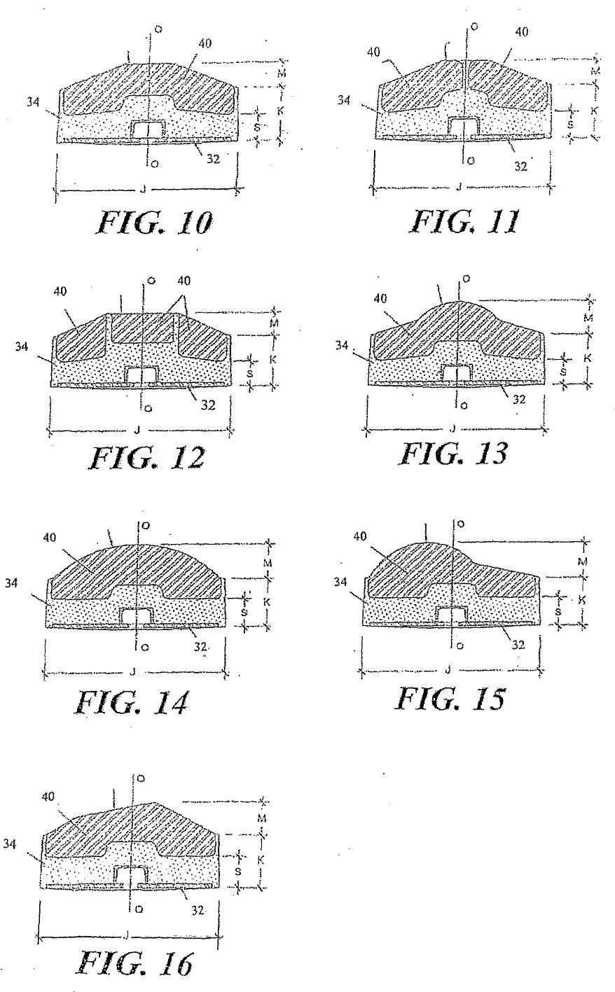

FIGS. 10 to 16 illustrate in cross section various configurations and shapes of the cushioning member and wear elements. FIGS. 10, 13, 14, 15 and 16 show a single row of wear elements 40 of different cross sectional shapes. FIG. 11 illustrates an arrangement with two rows of wear elements 40 and FIG. 12 three rows of wear elements.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A liner assembly for use in a grinding mill the grinding mill including a rotatable drum having an inner surface, the liner assembly including a mounting member which can be operatively secured to the inner surface of the drum, an elastomeric cushioning member which includes a base wall operatively connected to the mounting member, opposed side walls extending away from the base wall and terminating at an outer edge and an outer wall extending from the outer edge of the side walls, a plurality of support cavities in the outer wall thereof, and a plurality of wear elements, each support cavity having one of said wear elements mounted therein, the wear elements providing a wear surface substantially over the whole outer wall.

2. A liner assembly according to claim 1 wherein said cushioning member is an elongated body having said support cavities arranged in a row extending in the longitudinal axis of the elongated body.

3. A liner assembly according to claim 2 wherein there is provided two or more said rows of support cavities arranged side by side.

4. A liner assembly according to claim 3 wherein the support cavities in one row are offset with respect to the support cavities in an adjacent row.

5. A liner assembly according to claim 1 wherein the length of the cushioning member is between 2 to 12 times the width of the cushioning member.

6. A liner assembly according to claim 1 wherein the distance K from the base wall to the outer edge of the side walls is about the width of the lifting bar which forms part of the grinding mill.

7. A liner assembly according to claim 6 wherein the distance M from the outer edge of the side walls to an outermost region of the outer wall is about 1 to 40 cm.

8. A liner assembly according to claim 1 wherein the support cavities include a lower wall and the distance S from the base wall of the liner body to the lower wall of the support cavities is from 0.1 K to 0.9 K where K is the distance from the base wall to the outer edge of the side walls of the liner body.

9. A liner assembly according to claim 1 wherein the elastomeric cushioning member has a Shore hardness between 30 to 85 hardness Shore A.

10. A liner assembly according to claim 2 wherein adjacent cavities in a row are separated by a wall having a thickness from about 0.5 mm to 20 mm.

11. A liner assembly according to claim 1 wherein said wear elements are generally polyhedric in shape.

12. A liner assembly according to claim 1 wherein the wear elements have a Brinell hardness of between 350 to 800 B.

13. A liner assembly according to claim 1 wherein the side walls are slightly inclined towards one another from the base wall towards the outer wall.

14. A liner system for use in a grinding mill which includes a rotatable drum having an inner surface, the liner system including a plurality of lifter bars on the inner surface thereof, the lifter bars extending generally in the same direction as the axis of rotation of the drum, the lifter bars being circumferentially spaced apart around the inner surface of the shell so as to form channels therebetween, and a plurality of liner assemblies being a linwer assembly according to claim 1, the liner assemblies being disposed within respective channels with the mounting members secured to the inner surface of the shell.
